(19) United States
(12) Patent Application Publication
(10) Pub. No.: US 2015/0109802 A1
(43) Pub. Date: Apr. 23, 2015

(54) LED LIGHTING DEVICE

(71) Applicants: Han-byul CHANG, Seoul (KR); Do-hyeon LEE, Hwaseong-si (KR); Hyung-jin KIM, Gwangmyeong-si (KR); Kyung-soo PARK, Suwon-si (KR); Jong-yang CHOO, Yongin-si (KR)

(72) Inventors: Han-byul CHANG, Seoul (KR); Do-hyeon LEE, Hwaseong-si (KR); Hyung-jin KIM, Gwangmyeong-si (KR); Kyung-soo PARK, Suwon-si (KR); Jong-yang CHOO, Yongin-si (KR)

(21) Appl. No.: 14/515,224

(22) Filed: Oct. 15, 2014

(30) Foreign Application Priority Data
Oct. 17, 2013 (KR) 10-2013-0123939

(51) Int. Cl. F21K 99/00; F21V 23/06; F21V 17/16; F21V 23/00

(52) U.S. Cl. CPC F21K 9/175; F21V 23/005; F21V 23/06; F21V 17/16
USPC 362/374

(57) ABSTRACT

A light-emitting diode (LED) lighting device includes a cover member that is configured to expose a protruding portion of a connection terminal when pressure is applied to the cover member and to cover the protruding portion of the connection terminal when the pressure is removed. Thus, an electric and/or mechanical safety problem caused by the connection terminal that is exposed to the outside may be reduced.

### RELATED APPLICATIONS

This application claims the benefit of Korean Patent Application No. 10-2013-0123939, filed on Oct. 17, 2013, in the Korean Intellectual Property Office, the disclosure of which is incorporated herein in its entirety by reference.

### BACKGROUND

1. Field

One or more embodiments of the present invention relate to a light-emitting diode (LED) lighting device.

2. Description of the Related Art

Light-emitting diodes (LEDs) exhibiting low power consumption and long lifespan are highlighted as one of the next generation light sources to replace existing lighting devices. Recently, an LED lighting device has been developed as a module and widely distributed so as to replace existing lighting devices such as fluorescent lamps.

In particular, a tube-type LED lighting device, or “L-tube”, which is manufactured to have an external shape that is compatible with existing fluorescent lamps, is being used. In general, in such an external shape, since a connection terminal is exposed to the outside, there is a problem in electric and mechanical safety.

First, the connection terminal that externally protrudes like a pin may be damaged by external exposure and shock. Also, since the connection terminal employs a bi-directional power application method, there is a problem in electric safety.

An LED lighting device such as a tube-type LED lighting device includes a built-in type or external type AC-DC converter to be capable of operating with AC and has a structure in which power is applied bi-directionally. The bi-directional power application structure may lead to electric shock when the LED lighting device is installed on a lamp fixture. In detail, when a user who connected one end of a tube-type LED lighting device to a lamp fixture tries to connect the other end of the LED lighting device to the lamp fixture, the user may easily get a shock as a body part, for example, a hand, of the user touches an exposed terminal of the LED lighting device. Thus, there is a demand for a solution to the above electric and mechanical safety problems.

### SUMMARY

One or more embodiments of the present invention include a light-emitting diode (LED) lighting device which may solve electric and/or mechanical safety problems occurring due to a connection terminal that is externally exposed.

Additional aspects will be set forth in part in the description which follows and, in part, will be apparent from the description, or may be learned by practice of the presented embodiments.

According to one or more embodiments of the present invention, an LED lighting device includes a housing having an inner space of which opposite end portions are open, an LED module provided in the inner space of the housing and comprising a plurality of LED elements and a circuit board on which the plurality of LED elements are mounted, and first and second base caps provided at the opposite end portions of the housing, each of the first and second base caps comprising a connection terminal electrically connected to the LED module, an outer mechanical part coupled to each end portion of the housing, and a terminal fixing part fixing the connection terminal such that a protruding portion of the connection terminal protrudes over the outer mechanical part, in which each of the first and second base caps further comprises a cover member that exposes the protruding portion of the connection terminal when receiving pressure and covers the protruding portion of the connection terminal when the pressure is removed.

Two connection terminals may be provided as the connection terminal for each of the first and second base caps and at least one of the two connection terminals may be configured to apply power to the LED module.

Two openings may be provided in the cover member at positions corresponding to the two connection terminals. The cover member may include one opening through which the two connection terminal pass. The cover member may have a round external shape.

The at least one of the first and second base caps may further include an elastic member that is arranged between the cover member and the terminal fixing part, and the elastic member may be configured to allow the cover member to move when pressure is applied to the cover member so that the connection terminal is exposed and to restore the cover member to an original position when the pressure is removed so that the cover member covers the protruding portion of the connection terminal.

The movement of the cover member according to the applied pressure may be guided through an inner space provided by the outer mechanical part.

The cover member may be formed of a material having elasticity, and the cover member may be deformed when pressure is applied to the cover member so that the protruding portion of the connection terminal is exposed, and the cover member may be restored when the pressure is removed so that the cover member covers the protruding portion of the connection terminal.

One end portion of the cover member may be fixed by the outer mechanical part.

The cover member may be provided to both of the first and second base caps.

The housing may be formed of a transparent material and have a tube structure having an inner space. The housing may include a heat sink, on which the LED module is mounted, and a transparent cover that is provided on the heat sink to cover the LED module.

According to one or more embodiments of the present invention, a light-emitting diode (LED) lighting device includes a housing having an inner space of which opposite end portions are open, an LED module provided in the inner space of the housing and comprising a plurality of LED elements and a circuit board on which the plurality of LED elements are mounted, and first and second base caps provided at the opposite end portions of the housing, each of the first and second base caps comprising two pins and at least one of the two pins applying power to the LED module, in which each of the first and second base caps further comprises an outer mechanical part coupled to each end portion of the housing, a pin fixing part fixing the pins to protrude outside the outer mechanical part, and a cover member that is configured to cover the protruding portion of each pin and expose the protruding portion of each pin when receiving pressure.

Each of the first and second base caps may include an elastic member that is arranged between the cover member and the pin fixing part, and the elastic member may be configured to allow the cover member to move when pressure is applied to the cover member so that each pin is exposed and to be returned to an original position of the cover member when the pressure is removed so that the protruding portion of each pin is covered.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view schematically illustrating an LED lighting device according to an embodiment of the present invention;

FIG. 2 is a cross-sectional view of the LED lighting device of FIG. 1, taken in a widthwise direction;

FIG. 3 is an exploded perspective view of a base cap for the LED lighting device of FIG. 1;

FIGS. 4A and 4B are perspective views respectively illustrating a normal state and a pressed state of a cover member of the LED lighting device of FIG. 1;

FIGS. 5A and 5B are cross-sectional views of the base cap for explaining an operation of the cover member according to pressure applied thereto;

FIGS. 6A and 6B are cross-sectional views of the LED lighting device of FIG. 1, taken in a lengthwise direction thereof;

FIG. 7 illustrates a state in which the LED lighting device of FIG. 1 is being installed on a lamp fixture;

FIG. 8 is a cross-sectional view of an LED lighting device according to another embodiment (heat sink coupling) of the present invention, taken in a widthwise direction;

FIG. 9 is an exploded perspective view illustrating an LED lighting device according to another embodiment of the present invention;

FIGS. 10A and 10B illustrate a base cap for an LED lighting device according to another embodiment (base cap structure modification) of the present invention; and

FIG. 11 illustrates a cover member for an LED lighting device according to another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

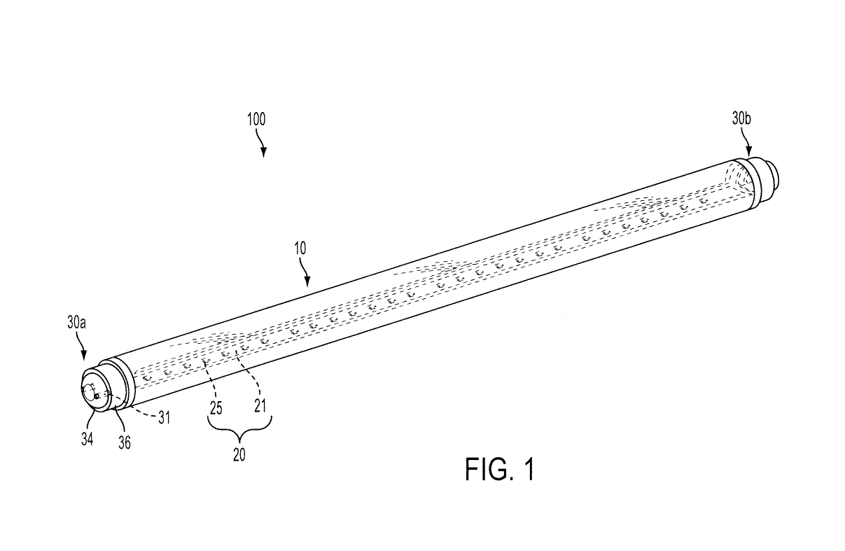

FIG. 1 is a perspective view schematically illustrating a light-emitting diode (LED) lighting device 100 according to an embodiment of the present invention.

The LED lighting device 100 according to the present embodiment may include a housing 10 having an inner space with open opposite end portions, an LED module 20 provided in the inner space of the housing 10, and first and second base caps 30a and 30b that are coupled to the opposite end portions of the housing 10.

The housing 10 may have a structure of a tube having open opposite end portions. An area that is defined to be at least a light-emitting surface in the housing 10 may be formed of a transparent material. The area that is defined to be a light-emitting surface may be determined according to a direction in which the LED elements 25 in the LED module 20 are provided.

The LED module 20 may include a circuit board 21 and a plurality of LED elements 25 that are mounted on the circuit board 21. The circuit board 21 may be appropriately embodied according to the shape of the housing 10. As in the present embodiment, when the housing 10 has substantially a tube shape, the circuit board 21 may be a rectangular board extending in a lengthwise direction of the housing 10.

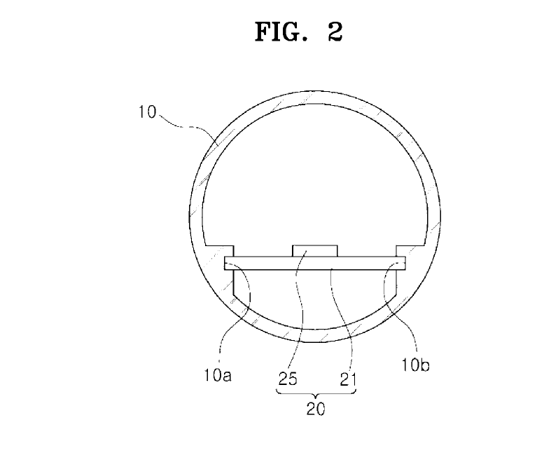

FIG. 2 is a cross-sectional view of the LED lighting device 100 of FIG. 1, taken in a widthwise direction. As illustrated in FIG. 2, coupling grooves 10a and 10b for coupling the LED module 20 may be provided inside the housing 10 having a tube shape. The coupling grooves 10a and 10b may be formed along the lengthwise direction of the housing 10 so that the circuit board 21 of the LED module 20 may be coupled to the coupling grooves 10a and 10b.

The circuit board 21 may be a printed circuit board (PCB). A circuit pattern may be formed on both sides of the circuit board 21, as necessary. Other elements, except for the LED elements 25, may be mounted on a surface of the circuit board 21 that is opposite to the light-emitting surface. In general, various elements such as a DC converter may be employed to embody a circuit for driving the LED elements 25 with a common AC voltage. The elements related to a DC converter may be provided outside the LED lighting device 100 as separate parts or included in the LED lighting device 100. When the elements are included in the LED lighting device 100, the DC converter and elements related thereto may be arranged on a surface of the circuit board 21 that is opposite to the surface where the LED elements 25 are mounted.

The LED elements 25 employed in the present embodiment may be an LED chip or a package in which an LED chip is mounted. The LED elements 25 may be serially or parallelly connected on the circuit board 21.

LED elements may be connected to operate at an AC voltage without a DC converter. In connection with an LED circuit capable of operating at an AC voltage, U.S. Pat. Nos. 8,026,675, 8,339,050, and 8,247,980 are incorporated by reference in their entirety.

The first and second base caps 30a and 30b are provided at the opposite end portions of the housing 10 and expose a connection terminal 31 when needed. As illustrated in FIG. 1, the connection terminal 31 may be a pin and have a structure in which two pins are provided at each end portion. The structure of the connection terminal 31 may be understood as a base cap structure according to a G13 standard for a tube-type lamp.

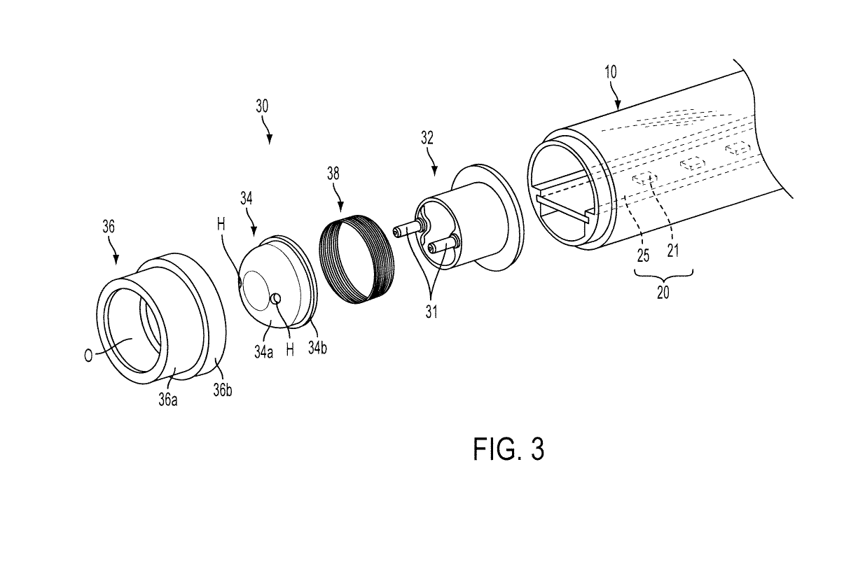

As illustrated in FIG. 3, the first and second base caps 30a and 30b employed in the present embodiment may include an outer mechanical part 36 coupled to an end portion of the housing 10 and a terminal fixing part 32 for fixing the two connection terminals 31. The connection terminal 31 is fixed to the terminal fixing part 32 such that a portion of the connection terminal 31 may protrude outside the outer mechanical part 36. The protruding portion of the connection terminal 31 may be provided as a part that directly connects to an external device such as a socket of a lamp fixture (not shown).

The first and second base caps 30a and 30b may each further include a cover member 34 for covering the protruding portion of the connection terminal 31. The cover member 34 employed in the present embodiment is not in a fixed state of covering the connection terminal 31. When pressure is applied to the cover member 34, the cover member 34 may be deformed or displaced so as to expose the protruding portion of the connection terminal 31.

The first and second based caps 30a and 30b may each further include an elastic member 38 that is arranged between the cover member 34 and the terminal fixing part 32. The elastic member 38 may be configured to allow the cover member 34 to move so as to expose the protruding portion of the connection terminal 31 when pressure is applied and to allow the cover member 34 to return to an original position so as to cover the protruding portion of the connection terminal 31 when the pressure is removed. Although in the present embodiment the elastic member 38 has a spring structure, other various elastic members capable of providing a desired restoration force may be used therefor.

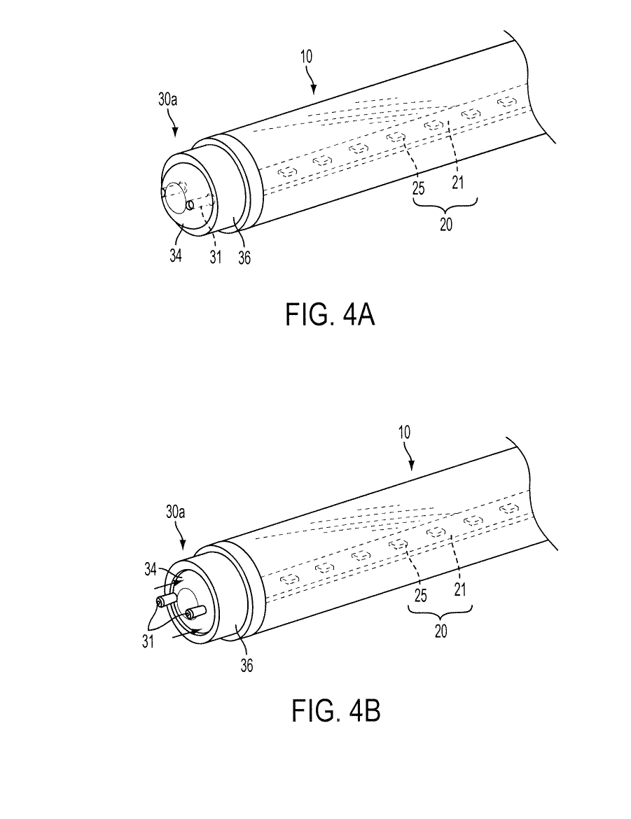

The operation of the cover member 34 is described below with reference to FIGS. 4A and 4B. In other words, in a normal state in which no pressure is applied to the cover member 34, as illustrated in FIG. 4A, the cover member 34 covers the protruding portion of the connection terminal 31. Since the cover member 34 does not completely expose the connection terminal 31 to the outside, the cover member 34 may protect the connection terminal 31 from external shock. Also, when the cover member 34 is formed of an electrically insulating material, external electrical connection may be prevented.

Due to pressure applied to the cover member 34 (see arrows in FIG. 4B), the cover member 34 may move into the inside of the outer mechanical part 36 so as to expose the protruding portion of the connection terminal 31, as illustrated in FIG. 4B.

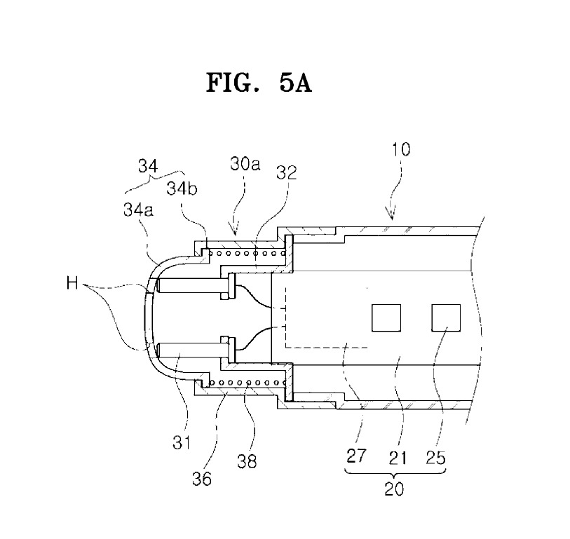

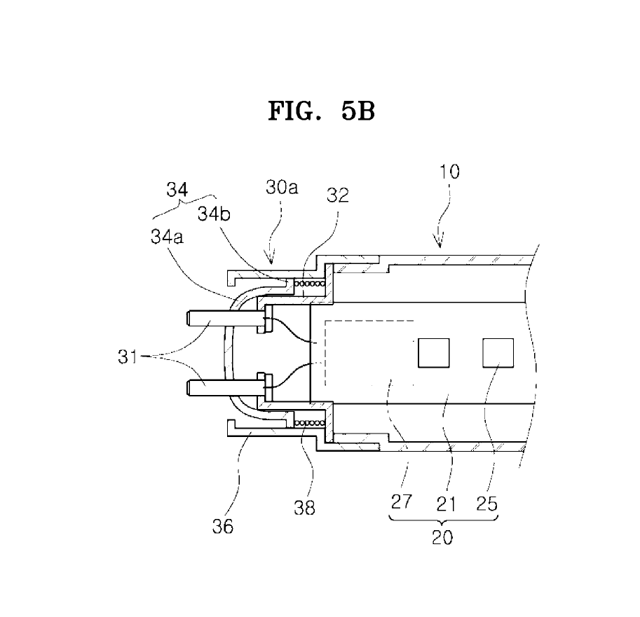

An example to embody the above operation is described in detail with reference to FIGS. 3, 5A, and 5B. FIGS. 5A and 5B, which respectively correspond to FIGS. 4A and 4B, illustrate a change in the inner structure of the first base cap 30a.

First, as illustrated in FIG. 5A, the two connection terminals 31, each being a pin, are coupled to the terminal fixing part 32 that is provided at the end portion of the housing 10. The connection terminal 31 is electrically connected to the LED module 20. The LED module 20 employed in the present embodiment may further include a DC converter 27 on a lower surface of the circuit board 21. The connection terminal 31 may supply electric power to the LED module 20 through the DC converter 27.

The outer mechanical part 36 may include a main body portion 36a having an open end portion O through which the connection terminal 31 is exposed and a connection portion 36b coupled to one end of the main body portion 36a. The outer mechanical part 36 may be coupled to the end portion of the housing 10 where the terminal fixing part 32 is provided, by using the connection portion 36b.

The cover member 34 may include a main body portion 34a having two openings H at positions corresponding to the two connection terminals 31 and a step portion 34b extended from a lower portion of the main body portion 34a. The elastic member 38 is arranged between a lower surface of the step portion 34b and another lower structure, for example, the terminal fixing part 32, to exert a force to push the cover member 34 outside. Accordingly, the cover member 34 may maintain a coupling state with the outer mechanical part 36 by using the step portion 34b.

When a pressure is applied to the cover member 34, as illustrated in FIG. 5B, the elastic member 38 supporting the cover member 34 is compressed and thus the cover member 34 enters an inner space of the outer mechanical part 36. Accordingly, the protruding portion of the connection terminal 31 may be exposed to the outside. The outer mechanical part 36 may function as a guide to guide the movement of the cover member 34. In other words, the cover member 34 may be embodied by using the inner space of the outer mechanical part 36.

Also, the cover member 34, in particular, the main body portion 34a, may have a round external shape so as to smoothly respond to pressure applied in various directions, for example, pressure partially applied to a lateral side during installation of the lamp fixture.

As described above, since the elastic member 38 such as a spring is employed in the present embodiment, the cover member 34 is returned to an original position when the pressure applied to the cover member 34 is removed. Accordingly, the protruding portion of the connection terminal 31 may be covered again by the cover member 34. For example, the cover member 34 may be configured to cover the connection terminal 31 again to not be exposed when the cover member 34 is separated from the lamp fixture.

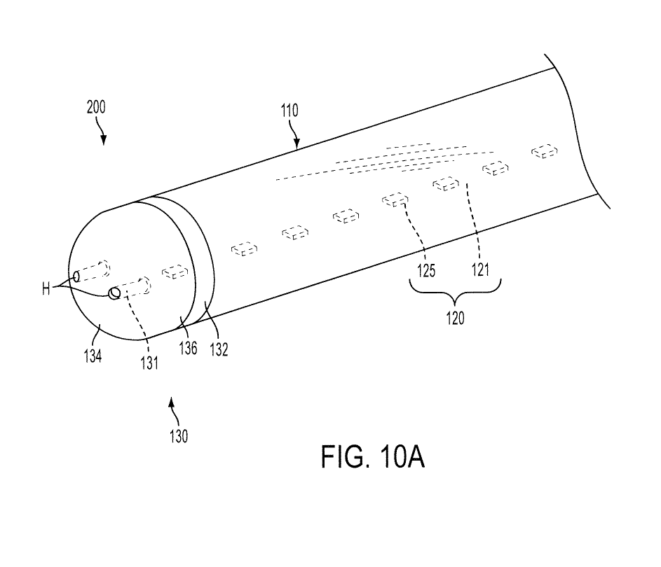

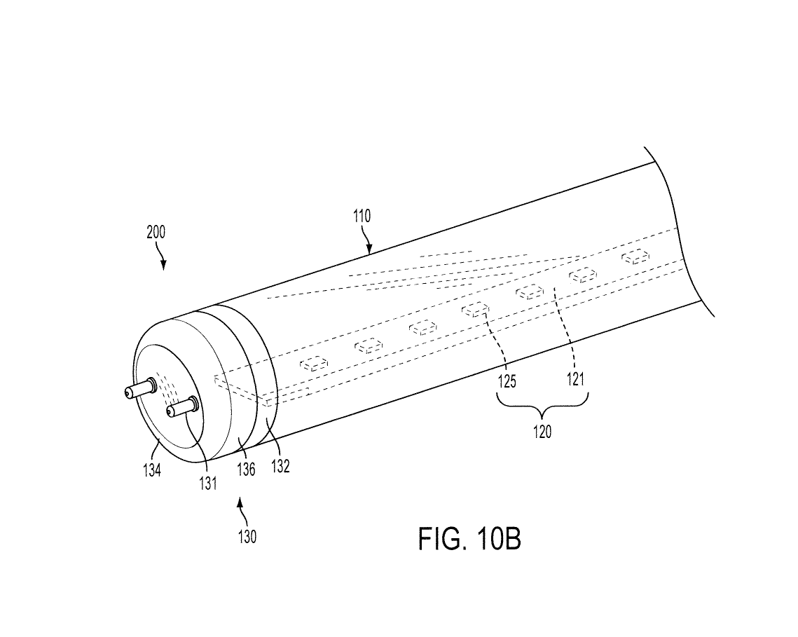

As such, the technical configuration of covering the connection terminal 31 again by using the elastic member 38 is not limited to the present embodiment and may be modified in various ways. For example, in addition to the method of changing/restoring the position of the cover member 34 by using the elastic member 38 such as a spring separate from the cover member 34 as in the present embodiment, a cover member itself is formed of an elastic material to be capable of being modified/restored, which is described below with reference to FIGS. 10A and 10B.

As described above, while no pressure is applied to the cover member 34, the cover member 34 covers the protruding portion of the connection terminal 31.

Accordingly, the cover member 34 may not only protect the connection terminal 31 from an external environment (moisture) or shock, but also improve safety against an electric shock. In particular, since the electric shock problem may be important in the LED lighting device 100 in which a voltage is applied bi-directionally, it is important to secure safety when a user installs the LED lighting device 100 on the lamp fixture.

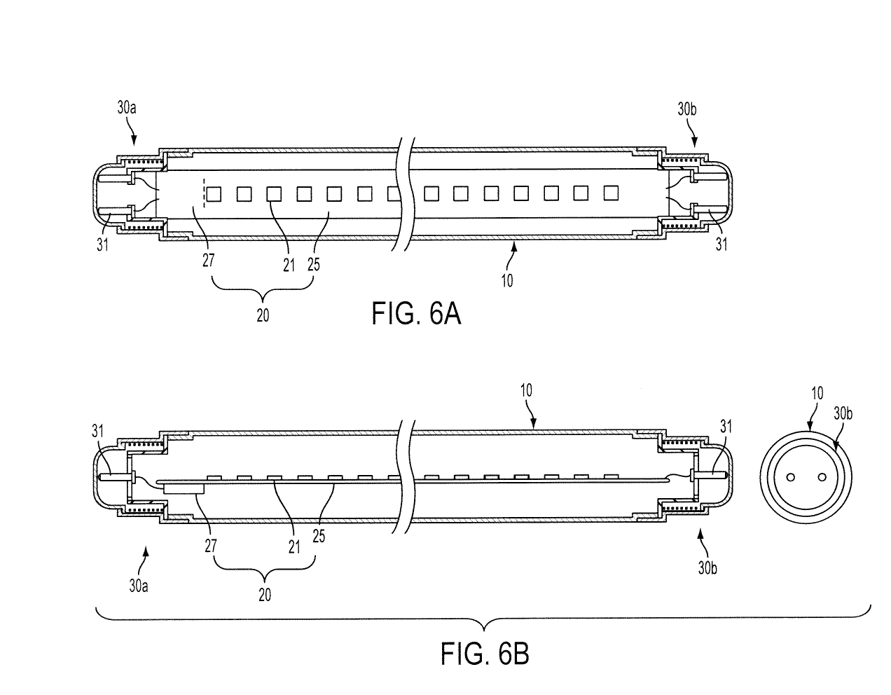

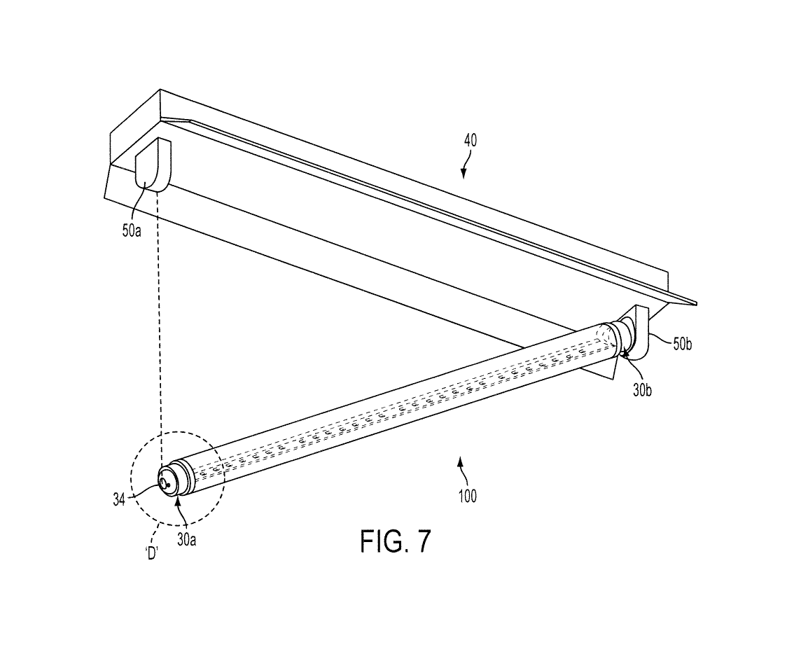

The merits and effects of the present invention are described with reference to FIGS. 6A, 6B, and 7. FIGS. 6A and 6B are cross-sectional views of the LED lighting device 100 of FIG. 1, taken in the lengthwise direction thereof.

As illustrated in FIGS. 6A and 6B, the connection terminal 31 provided at each opposite end portion of the housing 10 may be directly connected to the DC converter 27 of the LED module 20, and the LED elements 25 may be connected to the DC converter 27. In the present embodiment, although the two connection terminals 31 provided at each opposite end portion of the housing 10 are both illustrated to be connected to the DC converter 27, even when only one of the two connection terminals 31 is connected to the DC converter 27, a structure of applying a voltage bi-directionally may be available.

As such, the LED lighting device 100 may have a structure in which a voltage is applied bi-directionally. In other words, to supply a DC voltage for driving LEDs from an external AC power source, the AC power is received through the connection terminals 31 at the opposite end portions of the housing 10 to apply a desired DC driving voltage to the LED elements 25 via the DC converter 27.

Accordingly, since the LED lighting device 100 has a structure in which electricity may flow between the connection terminals 31 at the opposite end portions of the housing 10, as illustrated in FIG. 7, when installing the LED lighting device 100 on a lamp fixture 40, a user or operator may first connect the second base cap 30b at one side (a connection terminal corresponding to the second base cap 30b is electrically connected to a socket 50b) and then connect the first base cap 30a at the other side. In doing so, the user or operator may hold a portion “D” adjacent to the first base cap 30a with a hand.

In this case, there is no possibility of an electric shock due to contacting the portion “D” in a structure in which the two connection terminals 31 at each end portion are electrically connected to discharge as in an existing cold cathode fluorescent lamp. However, in the structure in which a voltage is applied bi-directionally as in the LED lightning device 100, a serious electric shock may occur.

The danger of electric shock may be prevented by employing the first and second base caps 30a and 30b each having the cover member 34 as described above. In other words, since the connection terminal 31 of the first base cap 30a is covered by the cover member 34 (see FIGS. 4A and 5A), in the installation process, the contact between the protruding portion of the connection terminal 31 and the user is prevented so that undesired electric shock may be prevented.

Also, when the installation of the LED lighting device 100 is completed by connecting the first base cap 30a to a socket 50a of the lamp fixture 40, the cover member 34 is pressed by the contact with the socket 50a to expose the protruding portion of the connection terminal 31 and thus a smooth electric/mechanical connection with the socket 50a may be guaranteed (FIGS. 4B and 5B).

Alternatively, only one of the first and second base caps 30a and 30b may be manufactured to have the cover member 34. However, in the present embodiment, for convenience of explanation, both the first and second base caps 30a and 30b are manufactured to have the cover member 34.

As such, the cover member 34 covers the connection terminal 31 before installation in order to prevent undesirable electric connection and exposes the protruding portion (connection area) of the connection terminal 31 during the installation process. Such operations may be very useful in the LED lighting device 100 of the present embodiment in which power is applied bi-directionally. In other words, as illustrated in FIG. 7, the operation of the cover member 34 may be smoothly performed in a process of installing the LED lighting device 100.

The present invention is not limited to the above-described embodiment and may be modified in various ways. For example, the structure of the housing 10 employed in the LED lighting device 100 may be modified in various ways.

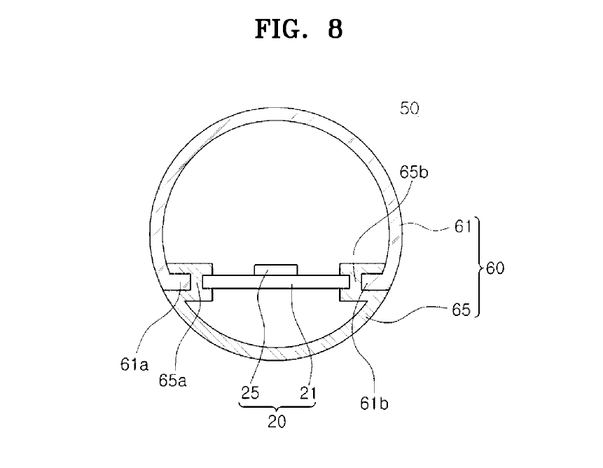

FIG. 8 is a cross-sectional view of an LED lighting device 100 according to another embodiment (heat sink coupling) of the present invention, taken in a widthwise direction.

The LED lighting device 100 of FIG. 8 may include a housing 60 having a -tube structure) and an LED light source module 20 provided inside the housing 60. The descriptions with reference to FIGS. 1 and 3 may be applied to the description of the present embodiment regarding other constituent elements except for the housing 60.

The housing 60 employed in the present embodiment may include a heat sink 65, on which the LED module 20 is mounted, and a transparent cover 61 covering the LED module 20.

As illustrated in FIG. 8, the heat sink 65 may include a pair of inner coupling grooves 65a and 65b for coupling with the LED module 20. The heat sink 65 may be formed of a material exhibiting a superior heat dissipation performance, for example, metal such as copper.

The transparent cover 61 may be coupled to the heat sink 65 by using coupling protrusions 61a and 61b that correspond to grooves provided at an upper end of the heat sink 65. The structure or material of the transparent cover 61 may be diversely modified for additional optical functions. For example, the transparent cover 61 may further include a diffusion agent to uniformly diffuse light generated by the LED module 20 or any other necessary optical structure.

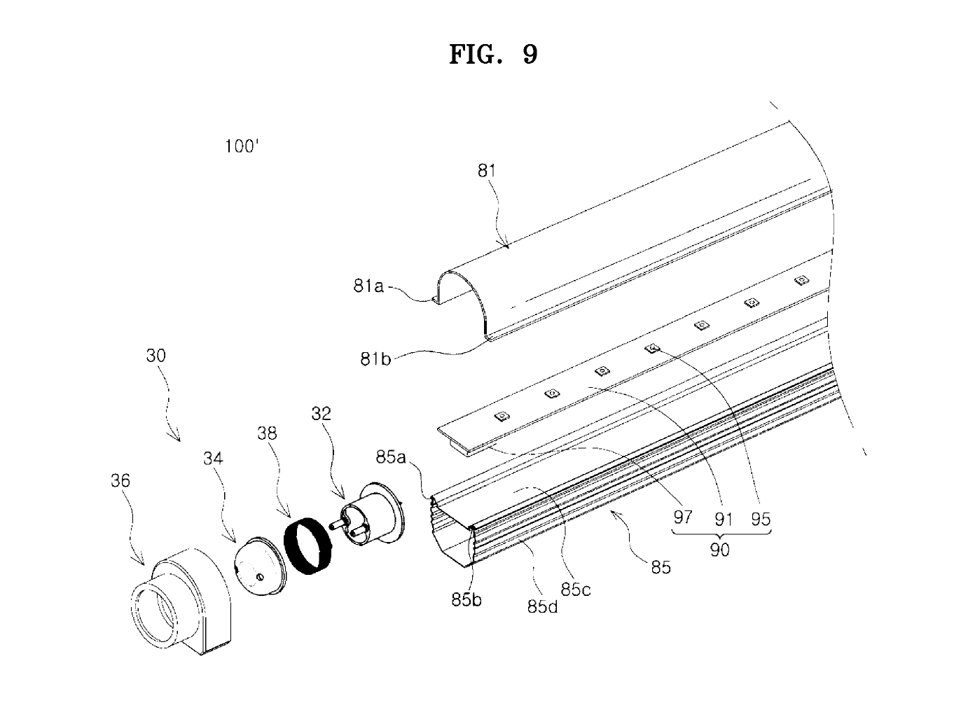

FIG. 9 is an exploded perspective view illustrating an LED lighting device 100′ having a housing 80 coupled with a heat sink 85 that has a similar shape to the one illustrated in FIG. 8

Referring to FIG. 9, the LED lighting device 100′ according to the present embodiment may include the housing 80 having an inner space with open opposite end portions, an LED module 90 provided in the inner space of the housing 80, and a base cap 30 provided at each end portion of the housing 80.

The base cap 30 employed in the present embodiment, as illustrated in FIG. 3, may include the terminal fixing part 32 where a pin is fixed, the outer mechanical part 36 coupled to one end portion of the housing 80, the cover member 34 configured to allow the protruding portion of the pin to be exposed when receiving pressure while covering the protruding portion of the pin, and the elastic member 38 providing a restoration force to the cover member 34.

The housing 80 may include the heat sink 85, on which the LED module 90 is mounted, and a transparent cover 81 covering the LED module 90, which is similar to the housing 60 of FIG. 8. The heat sink 85 may be manufactured of a material exhibiting a superior heat dissipation performance such as metal, for example, copper.

The heat sink 85 may have a pipe structure having an upper plate 85c, unlike the shape of FIG. 8. The LED module 90 may be arranged on the upper plate 85c of the heat sink 85. In the above arrangement, since the upper plate 85c of the heat sink 85 is coupled to a circuit board 91 or arranged adjacent to the circuit board 91 heat dissipation characteristics may be improved. A side surface 85d of the heat sink 85 may have a certain uneven structure. The uneven side surface 85d has a large surface area and thus the heat dissipation performance may be further improved.

The heat sink 85 may have coupling grooves 85a and 85b formed along a lengthwise direction thereof. The transparent cover 81 may include coupling protrusions 81a and 81b at opposite end portions of a main body structure having a lens shape. As the coupling protrusions 81a and 81b are coupled with the coupling grooves 85a and 85b, respectively, the transparent cover 81 may be coupled to the heat sink 85. The structure or material of the transparent cover 81 may be diversely modified for additional optical functions.

Although in the above-described embodiments a method of changing/restoring the position of a cover member by using an elastic member such as a spring in addition to the cover member is described as a technical configuration of covering a connection terminal again by using the elastic member, the cover member may be manufactured of an elastic material and the structure may be modified/restored unlike the above method.

FIGS. 10A and 10B illustrate an LED lighting device 200 in which a cover member 134 is formed of an elastic material, according to another embodiment of the present invention.

The LED lighting device 200 may include a housing 110 having an inner space with open opposite end portions, an LED module 120 provided in the inner space of the housing 110, and a base cap 130 provided at each end portion of the housing 110.

The base cap 130 employed in the present embodiment, as illustrated in FIG. 3, may include a terminal fixing part 132, on which a connection terminal 131 such as a pin is fixed, an outer mechanical part 136 coupled to one end portion of the housing 110, and the cover member 134 configured to allow a protruding portion of the connection terminal 131 to be exposed when receiving pressure while covering the protruding portion of the connection terminal 131. One end of the cover member 134 may be fixed by the outer mechanical part 136.

The cover member 134 employed in the present embodiment may be formed of a material having an elastic force such as rubber. When pressure is applied to the cover member 134, for example, when the LED lighting device 200 is installed on the lamp fixture, the cover member 134 is deformed to be pushed back so as to expose the protruding portion of the connection terminal 131, as illustrated in FIG. 10B. When the pressure is removed, for example, when the LED lighting device 200 is not yet installed or already installed on the lamp fixture, the cover member 134 is restored by an elastic force so as to cover the protruding portion of the connection terminal 131, as illustrated in FIG. 10A.

As such, a base cap, including a cover member, may be diversely modified. In other words, the base cap may have a variety of structures such that a protruding portion of a connection terminal, for example, a pin, is covered by the cover member and the protruding portion of the connection terminal is exposed by certain pressure, for example, pressure applied when the LED lighting device is installed on the lamp fixture, so as to be easily connected to a socket of the lamp fixture.

The above-described embodiments may be modified and provided as LED lighting devices replacing an existing standardized fluorescent lamp. Although in the above-described embodiments the base cap structure may be understood as one having a form that is proposed according to the G13 standard, the present invention is not limited thereto and other existing standardized base cap structures such as R17d and L16 may be embodied as the base cap structure. For example, for other standardized base cap structures, the structure of the cover member, in particular, the opening structure of the cover member, may be embodied by being modified to correspond to the shape of the connection terminal.

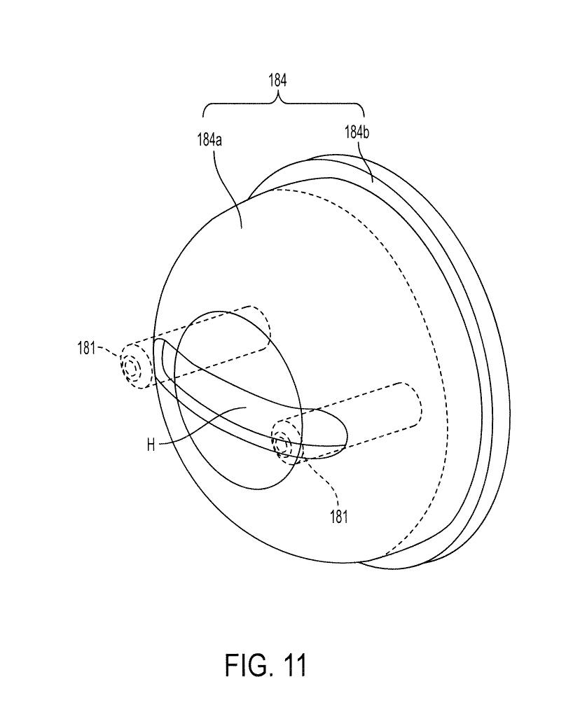

FIG. 11 illustrates a cover member 184 that is employed in an LED lighting device according to another embodiment of the present invention, in which the cover member has a shape suitable for a base cap of the R17d standard.

Referring to FIG. 11, the cover member 184 may include a main body portion 184a, in which an opening H is formed, and a hook step 184b provided on the lower end of the main body portion 184a. The opening H of the cover member 184 may be a slot-type opening that is suitable for the shape of a connection terminal such as the R17d standard.

For a lighting device having the R17d standard, two connection terminals 181 are provided in a protruding portion and the protruding portion thereof is accommodated in a socket. Accordingly, the lighting device may be connected to an external apparatus such as the lamp fixture. As such, the cover member 184 may have the opening H having a shape that is suitable for the cover member 184 so that a contact portion that is accommodated in the socket may be exposed. Thus, the cover member 184 may be easily applied to other types of lighting devices having various shapes

As described above, according to the one or more of the above embodiments of the present invention, not only a connection terminal such as a pin protruding outside may be prevented from being damaged by exposure and shock, but also electrical safety during handling, for example, installation on a lamp fixture, may be improved.

In particular, when an LED lighting device having a bi-directional power application structure is installed on a lamp fixture, a problem that causes an electric shock accident due to an undesired body contact with one connection terminal when an electric connection of the other connection terminal is completed may be solved. Simultaneously, a smooth installation may be guaranteed by exposing the connection terminal by using pressure in a process of installing the LED lighting device on the lamp fixture.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A light-emitting diode (LED) lighting device comprising:
a housing having an inner space of which opposite end portions are open;
an LED module provided in the inner space of the housing and comprising a plurality of LED elements and a circuit board on which the plurality of LED elements are mounted; and
first and second base caps provided at the opposite end portions of the housing, each of the first and second base caps comprising a connection terminal electrically connected to the LED module, an outer mechanical part coupled to each end portion of the housing, and a terminal fixing part fixing the connection terminal such that a protruding portion of the connection terminal protrudes over the outer mechanical part,
wherein each of the first and second base caps further comprises a cover member that exposes the protruding portion of the connection terminal when receiving pressure and covers the protruding portion of the connection terminal when the pressure is removed.

2. The LED illuminating device of claim 1, wherein two connection terminals are provided as the connection terminal for each of the first and second base caps and at least one of the two connection terminals is configured to apply power to the LED module.

3. The LED illuminating device of claim 2, wherein two openings are provided in the cover member at positions corresponding to the two connection terminals.

4. The LED illuminating device of claim 3, wherein the cover member has a round external shape.

5. The LED illuminating device of claim 4, wherein the at least one of the first and second base caps further comprises an elastic member that is arranged between the cover member and the terminal fixing part, and the elastic member is configured to allow the cover member to move when pressure is applied to the cover member so that the connection terminal is exposed and to restore the cover member to an original position when the pressure is removed so that the cover member covers the protruding portion of the connection terminal.

6. The LED illuminating device of claim 5, wherein the movement of the cover member according to the applied pressure is guided through an inner space provided by the outer mechanical part.

7. The LED illuminating device of claim 1, wherein the cover member is formed of a material having elasticity, and the cover member is deformed when pressure is applied to the cover member so that the protruding portion of the connection terminal is exposed, and the cover member is restored when the pressure is removed so that the cover member covers the protruding portion of the connection terminal.

8. The LED illuminating device of claim 7, wherein one end portion of the cover member is fixed by the outer mechanical part.

9. The LED illuminating device of claim 2, wherein the cover member comprises one opening through which the two connection terminal pass.

10. The LED illuminating device of claim 1, wherein the cover member is provided to both of the first and second base caps.

11. The LED illuminating device of claim 1, wherein the housing is formed of a transparent material and has a tube structure having an inner space.

12. The LED illuminating device of claim 1, wherein the housing comprises a heat sink, on which the LED module is mounted, and a transparent cover that is provided on the heat sink to cover the LED module.

13. A light-emitting diode (LED) lighting device comprising:
a housing having an inner space of which opposite end portions are open;
an LED module provided in the inner space of the housing and comprising a plurality of LED elements and a circuit board on which the plurality of LED elements are mounted; and
first and second base caps provided at the opposite end portions of the housing, each of the first and second base caps comprising two pins and at least one of the two pins applying power to the LED module,
wherein each of the first and second base caps further comprises an outer mechanical part coupled to each end portion of the housing, a pin fixing part fixing the pins to protrude outside the outer mechanical part, and a cover member that is configured to cover the protruding portion of each pin and expose the protruding portion of each pin when receiving pressure.

14. The LED illuminating device of claim 1, wherein, when the pressure is removed, the cover member is restored so as to cover the protruding portion of each pin.

15. The LED illuminating device of claim 14, wherein each of the first and second base caps comprises an elastic member that is arranged between the cover member and the pin fixing part, and the elastic member is configured to allow the cover member to move when pressure is applied to the cover member so that each pin is exposed and to be returned to an original position of the cover member when the pressure is removed so that the protruding portion of each pin is covered.
